(19) United States
(12) Patent Application Publication
(10) Pub. No.: US 2019/0014332 A1
(43) Pub. Date: Jan. 10, 2019

(54) CONTENT-AWARE VIDEO CODING

(71) Applicant: Apple Inc., Cupertino, CA (US)

(72) Inventors: Peikang Song, San Jose, CA (US); Xing Wen, Cupertino, CA (US); Sudeng Hu, San Jose, CA (US); Hang Yuan, San Jose, CA (US); Jae Hoon Kim, San Jose, CA (US); Dazhong Zhang, Milpitas, CA (US); Xiaosong Zhou, Campbell, CA (US); Hsi-Jung Wu, San Jose, CA (US)

(21) Appl. No.: 15/644,270

(22) Filed: Jul. 7, 2017

(51) Int. Cl. H04N 19/23; H04N 19/124; H04N 19/70; H04N 19/85; H04N 19/174; H04N 19/80; H04N 19/147

(52) U.S. Cl. CPC H04N 19/23; H04N 19/124; H04N 19/70; H04N 19/147; H04N 19/174; H04N 19/80; H04N 19/85

(57) ABSTRACT

Techniques for encoding and decoding video images based on image content types are described. Techniques include determining a plurality of image content types from metadata or an image content type recognition algorithm, where each image content type corresponding to a portion of a source video, such as a spatial or temporal portion. Encoding parameters, such as quantization parameter, may be selected for portions of source by a constrained search for encoding parameters, where the constraints are based on image content type.

This application relates to video communication technologies, including video compression and decompression.

### BACKGROUND

Video coding techniques include coding tools that allow encoding of source video at different bitrates while incurring different types and amounts of visual distortion. A video coding tool includes a collection of variable encoding parameters and related encoded bitstream syntax for communicating the parameters from an encoder to a decoder. Some video coding standards, such as H.264/AVC and H.265/HEVC, include a collection of video coding tools, such as motion prediction, quantization of transform coefficients, and post-processing filters.

Video may originate from a variety of sources, and image content from different sources may be mixed spatially or temporally into a single composite source video. Video sources may be grouped into categories according to content type, such as natural and synthetic. Natural content may include images created by sampling a real world scene with a camera, while synthetic content may include computer generated pixel data. Natural sources may be further categorized, for example, into indoor and outdoor content types or into naturally lit and synthetically lit natural scene content types. Synthetic content may include content types of such as scrolling text (such as in an investment stock ticker), animation of a computer user interface, or a video game.

Inventors perceive a need for better video coding techniques based on different video sources or different image content types.

### BRIEF DESCRIPTION OF THE DRAWINGS

FIG. 1A is a simplified block diagram of an example video encoding system.

FIG. 1B illustrates an example coding engine.

FIG. 2 depicts an example environment for video decoding based on image content type.

FIG. 3 depicts an example static image comprising a variety of content image content types.

FIG. 4 depicts an example method for video encoding based on image content type.

FIG. 5 depicts an example method for video decoding based on image content type.

### DETAILED DESCRIPTION

Techniques for encoding and decoding video based on source image content types are presented. Video encoding tools and encoding parameters may be selected based on a determined content type of source video. Mixed video sources comprising multiple content types may be encoded by selecting different tools or different parameters for use when encoding different portions of a source video, where the different portions correspond to different content types. Image content types may be associated with a profile specifying a collection of coding tools and parameters or ranges of parameters, and encoding of a particular image content type may use the corresponding profile. In one example, video encoding may be simplified by constraining a search for encoding parameters based on image content type. In another example, source video content type information may be encoded into a bitstream of compressed video, and then decoding techniques may also vary based on content type.

An encoder may determine the content type of video data to be encoded simply by knowing the source of the video. For example, an encoder may receive a metadata hint indicting content type along with the video data content to be encoded. A camera source may insert metadata indicating video sourced from that camera is a natural video content type, or an encoder may infer source content is a natural content type based on metadata indicating a certain model of camera, since cameras generally capture only natural content. In other embodiments where an encoder is not provided metadata from which content type can be inferred, content recognition algorithms may be used to determine content types. For example an optical character recognition algorithm may be used to detect a text content type, and a content type may be inferred from statistics gathered from source video images, such as a histogram of spatial frequencies that may correlate with certain content types. High degrees of image motion may indicate a video game content type. At the decoder, content type may in determined by an explicit indication of content type encoded in the syntax of a bitstream being decoded. Alternately, a decoder may infer content types from other encoded parameters and image data.

Mixed content may include multiple content types, including content from multiple sources that are composited into a single composite source video. Compositing may be temporal, spatial, or a mixture of temporal and spatial content types. Temporal compositing may include splicing in time where a first source of a first content type provides a first set of video frames, and a second set of video frames, immediately following the first set of video frames, is provided by a second source. Spatial compositing may include one or more video frames that contain one type of content in a first spatial region or spatial area, while a second spatial region includes another type of content. In some cases, the different video portions corresponding to different content types may be temporally and spatially disjointed from each other, or they may be overlapping. For example, a source video with a fade from one content type to another may have temporally overlapping content types during the fade.

Compression according to content type may provide improved compression as measured by a calculated distortion metric or as evaluated by human viewers. Different content types may have different statistical properties that relate to compressibility under a calculated distortion metric. Additionally, different content types may have different attributes of importance to human viewers of decompressed video that are not easily included in a calculated distortion metric. For example, for images with text, human viewers may value readability and preservation of sharp edges over preservation of color (chroma) integrity, while in some natural image sources, preservation of slowly changing color gradients may be more important than preservation of exact location of sharp edges. Hence, compression processes may benefit from knowledge of content type, for example by reducing encoding complexity or by reducing the human-perceived distortion induced by the compression process.

Collections of encoding parameters may be summarized in a profile associated with an image content type. A profile may include a list of coding tools, parameters, and parameter ranges that are to be used for particular content type. A profile may also include a list of coding tools, parameters and profile ranges that are not to be used for a particular content type. A profile may also have both an included list and excluded list.

Compression efficiency may be improved by constraining searches to certain encoding parameters based on content type. Video encoding generally includes searching across a large set of possible parameters to find parameters that yield the best balance of low encoded bitrate and low calculated distortion for a particular source video (or portion of source video). A profile specifying an included or excluded list may be used to constrain the search a particular image content type. With an included list, by affirmatively specifying a parameter set, no search outside the bounds of that parameter set need be performed.

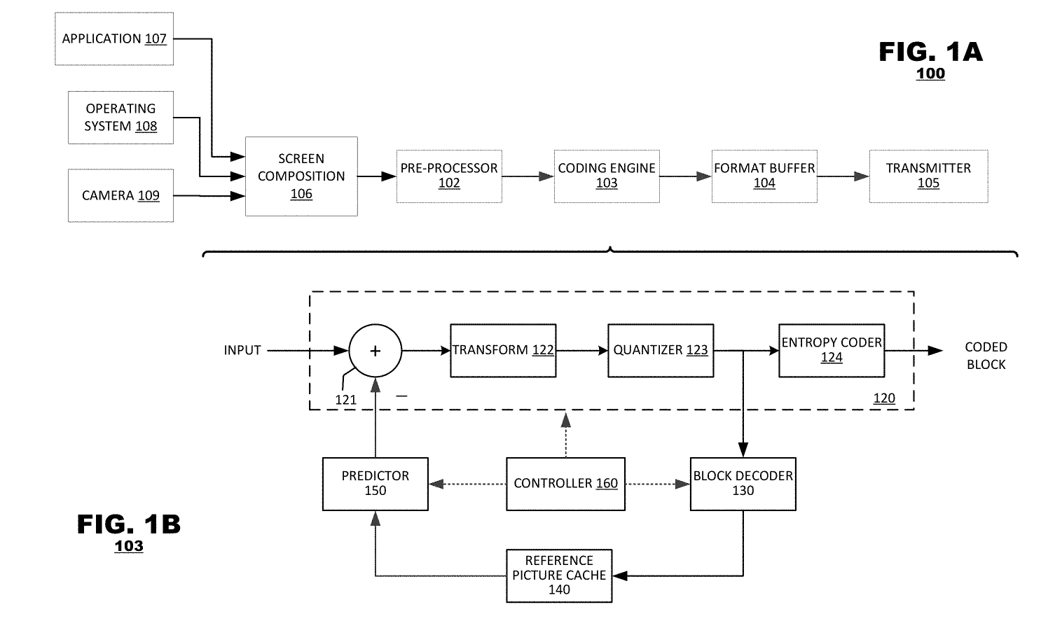

FIG. 1A is a simplified block diagram of an example video encoding system 100 as may be used in a source terminal of a video communication system, according to an embodiment of the present disclosure. Sources of images for encoding may include a computer application 107, an operating system 108 that generates user interface (UI) graphics, and a camera 109. An image composition function may combine images from multiple sources into composite images. In the example of FIG. 1A, screen composition function 106 combines user interface images from application 107, operating system 108, and camera source 109 into composite images supplied to the pre-processor 102. The encoding system 100 may further include a pre-processor 102, a coding engine 103, a format buffer 104, and a transmitter 105. The video sources may supply source video data to the rest of the system 100. Camera source 109 may capture video data representing local image data or may be storage units that store video data generated by some other system (not shown). Typically, the video data is organized into frames of image content.

The pre-processor 102 may perform various analytical and signal conditioning operations on video data. For example, the pre-processor 102 may apply various filtering operations to the frame data to improve efficiency of coding operations applied by a video coding engine 103. The pre-processor 102 may also perform analytical operations on the source video data to derive statistics of the video, which may be provided to the controller 160 of FIG. 1B to otherwise manage operations of the video coding system 100.

Video encoding system 100 may include an image content type recognition functions, which may, for example, be incorporated as an image content type recognition algorithm performed by pre-processor 102. An image content recognition algorithm may select one or more an image content types to associate with a particular temporal or spatial portion of source video, which controller 160 of FIG. 1B may use for encoding. Some image content type recognition algorithm may use object recognition algorithms to determine image content type. For example, recognition of a human face may indicate a natural image content type.

FIG. 1B illustrates a coding engine, according to an embodiment, which may find application as the coding engine 103 of FIG. 1A. The coding engine 103 may include a block coder 120, a block decoder 130, picture cache 140, and a prediction system 150, all operating under control of a controller 160. The block coder 120 is a forward coding chain that encodes pixel blocks for transmission to a decoder. A pixel block is a group of pixels that may be of different sizes in different embodiments, and a pixel block may correspond to the constructs at work in different protocols. A pixel block may correspond, for example, to either a block or a macroblock in the Moving Picture Experts Group (MPEG) video coding standards MPEG-2, MPEG-4 Part 2, H.263, or MPEG-4 AVC/H.264, or to either a coding unit (CU) or largest coding unit (LCU) in the HEVC/H.265 video coding standard. The block coder 120 may include a subtractor 121, a transform unit 122, a quantizer unit 123, and an entropy coder 124. The block decoder 130, picture cache 140, and prediction system 150 together form a prediction loop. A portion of the prediction loop, including the block decoder 130 and prediction system 150, operates on a pixel block-by-pixel block basis, while the remainder of the prediction loop, including picture cache 140, operates on multiple pixel blocks at a time, including operating on whole frames. The block decoder 130 may include an inverse quantizer unit, and an inverse transform unit and in-loop filters such as a de-blocking filter (not picture). The prediction system 150 may include motion estimation and compensation.

The subtractor 121 may receive an input signal and generate data representing a difference between a source pixel block and a reference block developed for prediction. The transform unit 122 may convert the difference to an array of transform coefficients, e.g., by a discrete cosine transform (DCT) process or wavelet transform. The quantizer unit 123 may quantize the transform coefficients obtained from the transform unit 122 by a quantization parameter QP. The entropy coder 124 may code the quantized coefficient data by run-value coding, run-length coding, arithmetic coding, or the like, and may generate coded video data, which is output from the coding engine 103. The output signal may then undergo further processing for transmission over a network, fixed media, etc. The output of the entropy coder 124 may be transmitted over a channel to a decoder, terminal, or data storage. In an embodiment, information can be passed to the decoder according to decisions of the encoder. The information passed to the decoder may be useful for decoding processes and reconstructing the video data.

Coding engine 103 may encode video images from these sources under the control of controller 160 to produce an encoded bitstream. Video coding system 100 may include image content recognition algorithms that identify image content types of portion of the image data provided to the encoder. In some embodiments, image content type information may be provided as metadata to coding engine 103 along with the image data. Image content type information, as provided in metadata or as determined by a recognition algorithm, may specify which portion of image source data corresponds to each image content type.

Image composition functions, such as may be included in screen composition 106, may splice image sources in time, or may combine separate image sources into a series of composite images where different sources occupy different spatial areas of one or more frames. Accordingly, image content information may specify a time range or range of frames that correspond to an image content type. And alternately or in addition, image content information may specify spatial areas within one or more frames that correspond to an image content type.

Controller 160 may determine image content type information, such as from metadata or an image content recognition algorithm, and the controller may base encoding decisions on image content type. For example, controller 160 may select encoding parameters or select encoding tools based on image content type. For example, the HEVC screen content coding extensions may be selected as a coding tool for the portion of source image data that is determined to have a synthetic image content type or be computer user interface content type. In another example, a controller 160 may select encoding parameters such as quantization parameters, an effective frame rate or refresh rate parameter, and an encoding latency parameter for use with a portion of source image content. Selected quantization parameters, for example, may be used by quantizer 123.

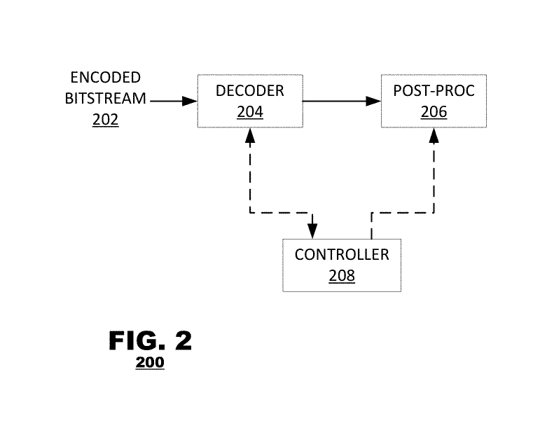

FIG. 2 depicts an example environment 200 for video decoding based on image content type. Input encoded bitstream 202 may be the encoded bitstream 114 output from video encoding system 100 of FIG. 1A. Decoder 204 may decode encoded bitstream 202, and post-processor 206 may apply a post-processing filter to the decoded images produced by decoder 204. Controller 208 may control decoder 204 and post-processing filter 206. An encoded bitstream may contain image content type information, for example encoded in a bitstream syntax that explicitly indicates both an image content type and a corresponding portion of the encoded images. Alternately, image content information may be inferred from other information encoded in the bitstream. For example, use of HEVC screen coding syntax may imply the portion of image content encoded with the screen coding tools is a synthetic image content type. Controller 208 may receive this image content type information, and may control post-processor 206 to apply a filter selected based on the image content type information. In one embodiment, decoder 204, controller 208, and post-processor 206 are all part of one communications terminal or a computer.

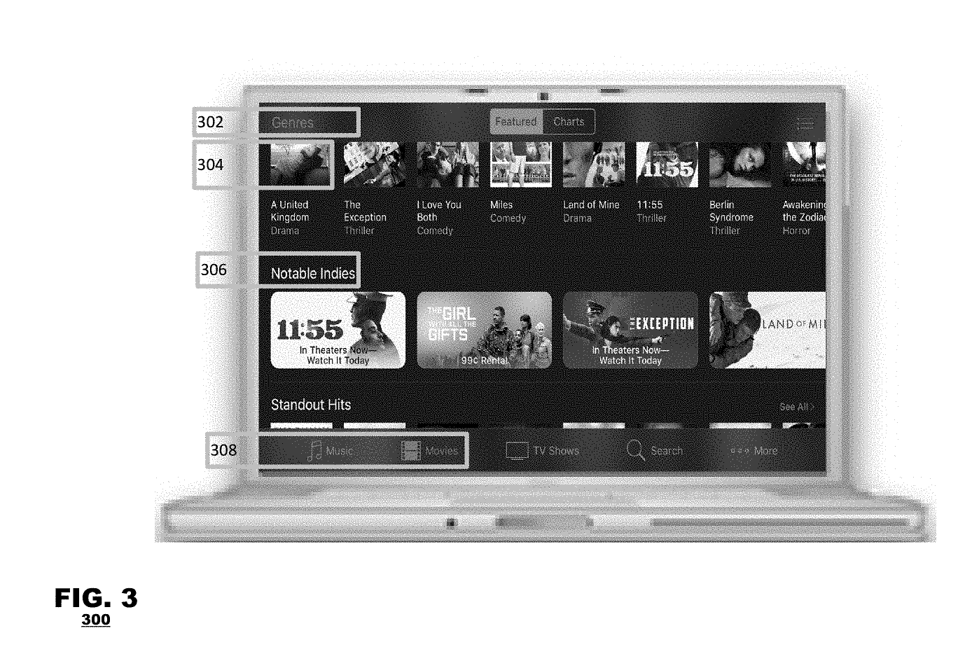

FIG. 3 depicts an example static image 300 comprising a variety of content image content types. A computer screen images often contain images composite from several sources, including sources of different image content types. In the example of FIG. 3, a computer screen 300 contains different content types in different spatial regions of the single depicted image. Spatial regions 302 and 306 contain a text image content type. Spatial region 304 contains a natural image content type as may have been captured by a camera of a natural scene. Spatial region 308 contains a computer graphics or computer user interface image content type. Alternate image content information for image 300 may specify region 308 as both computer graphics and text, and region 302 may be extended horizontally to include the entire top of image 300 as an image content type of computer user interface.

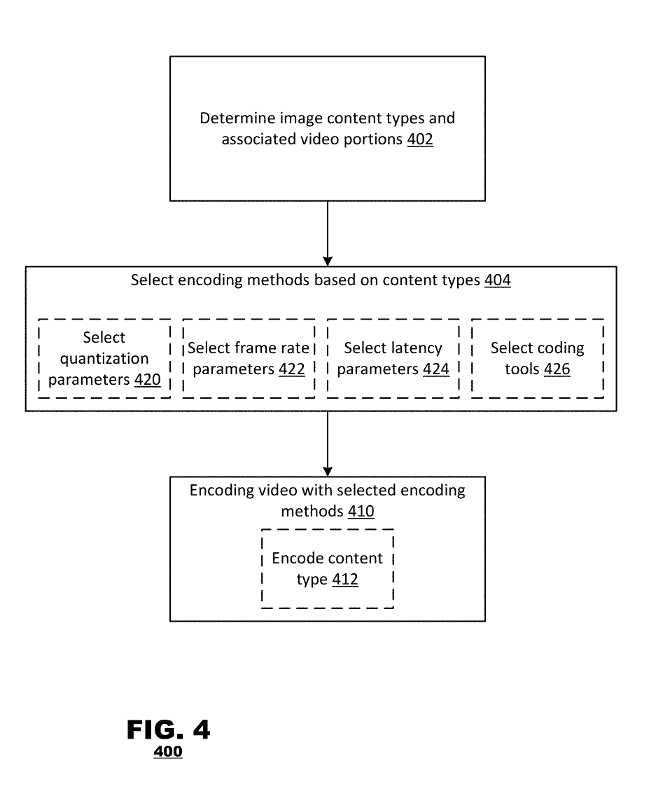

FIG. 4 depicts an example method 400 for video encoding based on image content type. In box 402, an encoding process may determine one or more content types for a source video to be encoded, and also determine which temporal or spatial portions of the source video are associated with the one or more content types. As discussed above, an encoder may determine content types, for example, from source video metadata or from a content type recognition algorithm. In box 404, encoding methods may be selected based on the determined content types. For example, coding tools may be selected based on content type in optionally box 426, quantization parameters may be selected based on content type in optional box 420, frame rate parameters may be selected based on content type in optional box 422, and latency parameters may be selected based on content type in optional box 424. In box 410, the source video may be encoded with the selected encoding methods. For example, each portion of source video may be encoded with the encoding methods selected for the portion's associated image content type. In optional box 412, image content type information may be encoded into the encoded video bitstream, where the information may include an indication of image content type and of the spatial and temporal portion of the encoded video that corresponds to the image content type. Following encoding, the encoded bitstream may be transmitted to a decoder, or stored for later use.

Encoding method selection in box 404 may be based on profiles associated with the determined image content types. For example, a profile may specify or constrain coding parameters or encoding tools. Such constraints may simplify the encoding process and reduce encoding complexity of portions of source video based on the determined image content types.

Quantization parameters (QP) that may be selected in box 420 include a QP range, and a delta QP for QP modulation. In some embodiments, a QP range may be selected by a rate controller at a higher level, such as selected once at the frame level (for the portions of the fame corresponding to a single image content type), and then fine-tuned at a lower level, such as at the block level, in a process called QP modulation. The degree to which a high-level QP range may be modulated at a lower level may be controlled by a delta QP parameter. In some cases, QP modulation may use spatial masking or temporal masking to mimic the human visual system.

An encoder may perform rate control by adjusting quantization parameters to control the output bitrate of an encoded bitstream. Rate control may include selection of a QP range and a delta QP for QP modulation. For example, a wide QP range may be selected for portions of video with natural image content types, and a narrow QP range may be selected for portions of video with synthetic or computer graphic image content types. In another example a smaller delta QP for QP modulation may be used for synthetic or computer graphic content, while a larger delta QP for QP modulation may be used for natural image content.

Rate control may be performed differently for different portions of a source video. With temporal compositing of content types, QP parameters may vary at the frame or higher layers, while with spatial compositing of content types, QP parameters may vary at the block-level such that QP parameters may vary within a frame.

Frame rate parameters that may be selected in box 422 include a preference for higher or lower effective encoded frame rate. Given a maximum encoded bitrate, a higher effective frame rate may yield a lower spatial visual quality, while a lower effective frame rate may yield high spatial visual quality. For some content types, such as computer games or other content types with high degrees of motion, a viewer's perceived video quality may depend more the accuracy of motion and a higher framerate, while for other content such as natural images or text, a viewer's perceived video quality may depend more on the accuracy of every rendered frame and less on the motion between frames. Hence a preference for a higher effective frame rate may be selected for portions of source video with high degrees of motion, while a preference for a lower effective frame rate may be selected for other portions of source video.

In source video with spatially heterogeneous image content types, a single actual encoded frame rate must usually apply to entire frames. However, an effectively heterogeneous frame rate can be achieved by encoding less or no information for some frames in the spatial portions with a low frame rate preference. In a first example, a macroblock skip mode can be used to skip encoding of macroblocks in every other frame that are within a portion having a low frame rate preference. The result maybe an effective frame rate in the low-frame-rate portion that is half of the effective frame rate of the remaining high-frame-rate portion. In a second example, different spatial portions may be grouped into encoded slices or tiles, and then different slices or tiles are encoded with different frame rates. In a third example, different spatial content regions may be separated into separate network access layer (NAL) units.

Quantization parameters may vary along with a preference for an effective frame rate. Doing so may preserve encoded bit-budget targets for video portions with varying effective frame rates. For example, lower QP (used to throw less information away by quantization) may be used where lower effective frame rates are preferred, while higher QP (used to throw more information away by quantization) may be used where higher effective frame rates are preferred.

In optional box 424, a preference for lower latency or higher latency may be selected according to image content type. Image content types may be associated with a viewer preference for low latency, where the time between an source image being input to an encoder and output from a decoder should be small, or high latency, where the time delay for encoding, transmission, and decoding is not as important. For example, news content types, such as a stock price ticker scroll, may have a low latency preference. In comparison, a viewer may have tolerance for high latency for movie content types.

A video may be encoded with lower latency, for example, by not using bi-directional motion prediction (B-frames). Use of bi-directional motion prediction, particularly in a hierarchical structure, can improve quality at a fixed encoded bitrate, but will incur latency delays at both the encoder and decoder. Similarly a multi-pass encoder may improve compression quality at the expense of longer latency. Accordingly, hierarchical B-frame and multi-pass encoding may be used for video portions without a low-latency preference, while B-frames and multi-pass encoding may not be used for portions with a low-latency preference.

Video can be encoded with different spatial latency preferences in the same way different spatial effective frame rate preferences were encoded above. For example, spatial regions may be separated at the block level, slice/tile level, or NAL level according to different spatial latency preferences.

In optional box 426, coding tools may be selected based on content types. For example H.265 intra block copy or HEVC's screen coding tools may have been designed to efficiently encode computer screen content. If an encoder knows a portion's image content type is not a type of computer screen content, the encoder may more efficiently encode that image portion by spending less time or other computing resources attempting to use such tools. For example, if a portion's content type is natural images from a camera, the encoder may skip any attempt to use H.256's intra block copy coding tool.

Optional block 412 may encode information about image content type into the encoded bitstream. In some cases, a video may be more efficiently coded by changing the allowed bitstream syntax based on an encoded image content type. For example, if a slice or tile is encoded as a certain image content type that is never encoded with certain encoding tools, the bitstream syntax used may allow that image content type to be specified, and then disallow syntax related to the coding tools that are never used on that image content type. By disallowing some options in the syntax of an encoded bitstream, the syntax overhead becomes smaller and resulting encoded bitstreams may become more efficient.

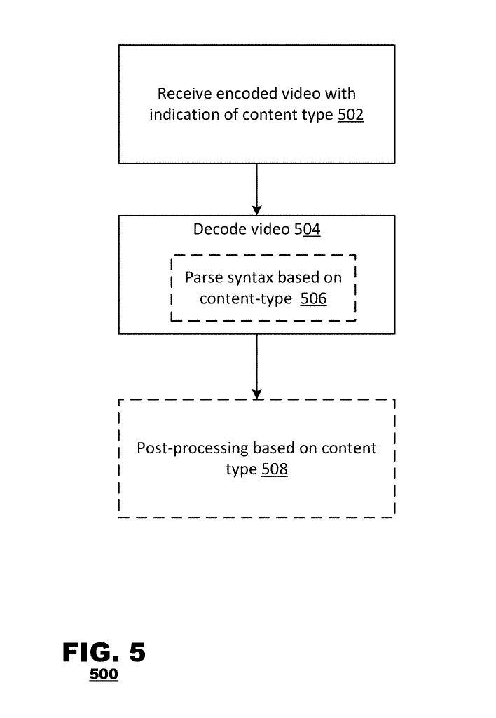

FIG. 5 depicts an example method 500 for video decoding based on image content type. In box 502, an encoded video with an indication of image content type is received. The indication of content type may include an indication of which portion of video corresponds to the indicated content type. In box 504, video may be decoded. If encoded bitstream syntax is dependent on image content type, for example as described above regarding box 412 of FIG. 4, decoding may include optional box 506 for parsing the syntax of the encoded bitstream based on the indication of content type. Finally, in optional box 508, decompressed image data may have a pro-processing filter applied based on the indication of image content type.

As discussed above, FIGS. 1A and 2 may illustrate functional block diagrams of communications terminals. In implementation, the terminals may be embodied as hardware systems, in which case, the illustrated blocks may correspond to circuit sub-systems. Alternatively, the terminals may be embodied as software systems, in which case, the blocks illustrated may correspond to program modules within software programs executed by a computer processor. In yet another embodiment, the terminals may be hybrid systems involving both hardware circuit systems and software programs. Moreover, not all of the functional blocks described herein need be provided or need be provided as separate units. For example, although FIG. 1A illustrates the components of an exemplary encoder terminal, including components such as the coding engine 103 and pre-processor 102, as separate units. In one or more embodiments, some components may be integrated. Such implementation details are immaterial to the operation of the present invention unless otherwise noted above. Similarly, the encoding, decoding and post-processing operations described with relation to FIGS. 4 and 5 may be performed continuously as data is input into the encoder/decoder. The order of the steps as described above does not limit the order of operations.

Some embodiments may be implemented, for example, using a non-transitory computer-readable storage medium or article which may store an instruction or a set of instructions that, if executed by a processor, may cause the processor to perform a method in accordance with the disclosed embodiments. The exemplary methods and computer program instructions may be embodied on a non-transitory machine readable storage medium. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method for video encoding, comprising:
determining a plurality of image content types, each corresponding to a portion of a source video;
selecting encoding parameters for the portions by searching for encoding parameters, wherein the search is constrained by the portion's corresponding image content type; and
encoding the source video by encoding the portions of the source video with the selected parameters.

2. The method of claim 1, wherein the searching is constrained by a profile associated with the image content type specifying encoding parameters corresponding constraints.

3. The method of claim 1, wherein:
the plurality of image content types correspond to different spatial regions of the same one or more frames of the source video; and
the different spatial regions are encoded differently based their corresponding image content type.

4. The method of claim 1, wherein the plurality of image content types is determined by an image content recognition algorithm.

5. The method of claim 1, further comprising:
determining quantization parameters for a portion of the source video based on the corresponding image content type.

6. The method of claim 1, further comprising:
performing rate control during the encoding of a portion by selecting a quantization range based on the portion's corresponding image content type, where a wider quantization range is selected for natural content types, and a smaller quantization range is selected for synthetic content types.

7. The method of claim 1, further comprising:
performing rate control during the encoding of a portion by selecting a delta quantization parameter for quantization parameter modulation based on the portion's corresponding image content type.

8. The method of claim 1, wherein different coding tools are used for the different portions of source video based on image content type.

9. The method of claim 1, wherein the encoding includes an indication of the image content types included in an encoded bitstream.

10. The method of claim 1, wherein the portions of the source video are encoded with either a high-frame-rate preference or a high-spatial-quality preference based on the corresponding image content type, the portions include different spatial portions of the same set of frames, and further comprising:
encoding the different spatial portions at different effective framerates based on their corresponding image content types.

11. The method of claim 1, wherein the portions of the source video are encoded with a high-latency preference or a low-latency preference based on the corresponding image content type, the portions include different spatial portions of the same set of frames, further comprising:
encoding the different spatial portions with different latencies based on their corresponding image content types.

12. A method for video decoding, comprising:
determining an image content type from a syntax of an encoded bitstream; and
decoding a portion of the encoded bitstream based on the image content type.

13. The method of claim 12, further comprising:
parsing the syntax of a portion of the encoded bitstream based on the image content type.

14. The method of claim 12, further comprising:
applying a post-processing filter to a portion of decoded video based on the image content type.

15. A system for video encoding, comprising a computer with a memory and instructions, that when executed by the computer, cause:
determining a plurality of image content types, each corresponding to a portion of a source video;
selecting encoding parameters for the portions by searching for encoding parameters, wherein the search is constrained by the portion's corresponding image content type; and
encoding the source video by encoding the portions of the source video with the selected parameters.

16. The system of claim 15, wherein the instructions further causing:
performing rate control during the encoding of a portion by selecting a quantization range based on the portion's corresponding image content type, where a wider quantization range is selected for natural content types, and a smaller quantization range is selected for synthetic content types.

17. The system of claim 15, wherein the instructions further causing:
performing rate control during the encoding of a portion by selecting a delta quantization parameter for quantization parameter modulation based on the portion's corresponding image content type.

18. A system for video encoding, comprising a computer with a memory and instructions, that when executed by the computer, cause:
determining an image content type from a syntax of an encoded bitstream; and
decoding a portion of the encoded bitstream based on the image content type.

19. A non-transitory computer-readable storage medium comprising instructions, that when executed by a processor, cause:
determining a plurality of image content types, each corresponding to a portion of a source video;
selecting encoding parameters for the portions by searching for encoding parameters, wherein the search is constrained by the portion's corresponding image content type; and
encoding the source video by encoding the portions of the source video with the selected parameters.

20. A non-transitory computer-readable storage medium comprising instructions, that when executed by a processor, cause:
determining an image content type from a syntax of an encoded bitstream; and
decoding a portion of the encoded bitstream based on the image content type.
